(19) United States
(12) Patent Application Publication
(10) Pub. No.: US 2022/0176903 A1
(43) Pub. Date: Jun. 9, 2022

(54) WIRELESS OCCUPANCY SENSORS AND METHODS FOR USING THE SAME

(71) Applicant: Sidewalk Labs LLC, New York, NY (US)

(72) Inventor: Thomas Joseph Kennedy, Brooklyn, NY (US)

(21) Appl. No.: 17/542,086

(22) Filed: Dec. 3, 2021

Related U.S. Application Data
(60) Provisional application No. 63/121,218, filed on Dec. 3, 2020.

(51) Int. Cl. B60R 21/015

(52) U.S. Cl. CPC B60R 21/01532; B60R 21/01534

(57) ABSTRACT

Wireless occupancy sensors and methods for using the same are provided. In some embodiments, an occupancy sensor includes: a magnetometer that detects changes in a magnetic field when a vehicle moves over the magnetometer; an optical sensor that detects one or more objects in a field of view of the optical sensor; a transmitter for transmitting sensor data to a gateway device, and a processor that controls the magnetometer, the optical sensor, and the transmitter. In some embodiments, the processor is configured to: detect, using the magnetometer, that a change in the magnetic field is greater than a particular threshold value; in response to the magnetometer detecting that the change in the magnetic field is greater than the particular threshold value, activating the optical sensor; receive, using the optical sensor, the sensor data associated with the one or more objects in the field of view of the optical sensor; and transmit, using the transmitter, the sensor data to the gateway device.

### CROSS-REFERENCE TO RELATED APPLICATIONS

This application claims the benefit of U.S. Provisional Patent Application No. 63/121,218, filed Dec. 3, 2020, which is hereby incorporated by reference herein in its entirety.

### TECHNICAL FIELD

The disclosed subject matter relates to wireless occupancy sensors and methods for using the same. More particularly, the disclosed subject matter relates to wireless occupancy sensors that can be used to provide privacy-sensitive methods, systems, and media for detecting the presence of a vehicle and generating and/or presenting real-time parking information.

### BACKGROUND

Vehicle drivers frequently spend a lot of time searching for parking spaces. For example, this search for parking spaces can include searching for on-street parking at a curb, which wastes time, creates congestion, unnecessarily consumes fuel or battery life, and/or creates vehicle emissions as such drivers continuously search for the perfect space at or near their destination. In another example, this search for parking spaces can include searching for off-street parking in a parking garage or a parking lot, which occupies valuable real estate that might otherwise be used to provide additional housing options. In some instances, the need for a parking garage or a parking lot may contribute to higher rent demands.

A driver may want to access a map or list of available parking spots in a particular location. However, this can be difficult to collate. Moreover, many cities are working toward a future with much less parking than is typically available today. Even further, although parking sensor devices have been developed in an attempt to solve these problems, such parking sensor devices tend to be overly expensive or unnecessarily invasive.

Accordingly, it is desirable to provide new wireless occupancy sensors and methods for using the same.

### SUMMARY

Wireless occupancy sensors and methods for using the same are provided.

In accordance with some embodiments of the disclosed subject matter, an occupancy sensor is provided, the occupancy sensor comprising: a magnetometer that detects changes in a magnetic field when a vehicle moves over the magnetometer; an optical sensor that detects one or more objects in a field of view of the optical sensor; a transmitter for transmitting sensor data to a gateway device, and a processor that controls the magnetometer, the optical sensor, and the transmitter, wherein the processor is configured to: detect, using the magnetometer, that a change in the magnetic field is greater than a particular threshold value; in response to the magnetometer detecting that the change in the magnetic field is greater than the particular threshold value, activating the optical sensor; receive, using the optical sensor, the sensor data associated with the one or more objects in the field of view of the optical sensor; and transmit, using the transmitter, the sensor data to the gateway device.

In some embodiments, the magnetometer is a low-power magnetometer.

In some embodiments, the processor is configured to receive the change in the magnetic field from the magnetometer via a serial interface between the magnetometer and the processor.

In some embodiments, the optical sensor is an infrared sensor. In some embodiments, the processor is further configured to determine that the vehicle is positioned over the occupancy sensor based on the amount of reflected light detected by the optical sensor being greater than a baseline amount of reflected light at a time when no vehicle is positioned over the occupancy sensor.

In some embodiments, the optical sensor is configured to emit light from a light source and measure an amount of reflected light from the one or more objects in the field of view of the optical sensor and wherein the sensor data includes the amount of reflected light from the one or more objects in the field of view of the optical sensor.

In some embodiments, the light source is a light emitting diode. In some embodiments, the processor is further configured to determine that the vehicle is positioned over the occupancy sensor based on the amount of reflected light detected by the optical sensor.

In some embodiments, the processor is further configured to transmit data from the magnetometer to the gateway device, wherein the data includes the detected change in the magnetic field when the vehicle moves over the magnetometer.

In some embodiments, the processor is further configured to transmit an identifier associated with a location at which the occupancy sensor is located along with the sensor data associated with the one or more objects in the field of view of the optical sensor. In some embodiments, the identifier is a parking lot identifier. In some embodiments, the identifier is a parking spot identifier.

In some embodiments, the processor is further configured to encrypt messages transmitted to the gateway device, wherein the encrypted messages include at least one of the sensor data received from the optical sensor and the detected change in the magnetic field when the vehicle moves over the magnetometer. In some embodiments, the processor is further configured to store one or more encryption keys in a memory of the occupancy sensor for encrypting messages that transmitted to the gateway device.

In some embodiments, the transmitter is a wireless transmitter and further comprising an antenna coupled to an output of the transmitter.

In some embodiments, the transmitter is a radio frequency transmitter.

In some embodiments, the occupancy sensor further comprises a battery that is connected to the processor.

In accordance with some embodiments of the disclosed subject matter, a parking system is provided, the parking system comprising an occupancy sensor that includes: a magnetometer that detects changes in a magnetic field when a vehicle moves over the magnetometer; an optical sensor that detects one or more objects in a field of view of the optical sensor; a transmitter for transmitting sensor data to a gateway device, and a processor that controls the magnetometer, the optical sensor, and the transmitter, wherein the processor is configured to: detect, using the magnetometer, that a change in the magnetic field is greater than a particular threshold value; in response to the magnetometer detecting that the change in the magnetic field is greater than the particular threshold value, activating the optical sensor; receive, using the optical sensor, the sensor data associated with the one or more objects in the field of view of the optical sensor; and transmit, using the transmitter, the sensor data to the gateway device. In some embodiments, the parking system further comprises a parking location in which the occupancy sensor is installed at a region of the parking location.

In some embodiments, an epoxy adhesive is applied between a rear portion of the occupancy sensor and the region of the parking location.

In some embodiments, a butyl pad is positioned between a rear portion of the occupancy sensor and the region of the parking location.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show example schematic diagrams for use of vehicle sensors in accordance with some embodiments of the disclosed subject matter.

FIG. 2 shows a detailed example of hardware that can be used in a vehicle sensor in accordance with some embodiments of the disclosed subject matter.

FIG. 3 shows an illustrative example of a process for generating and presenting parking information using one or more vehicle sensors in accordance with some embodiments of the disclosed subject matter.

FIGS. 4A and 4B show example user interfaces for presenting parking information based on data from one or more vehicle sensors in accordance with some embodiments of the disclosed subject matter.

FIGS. 5A, 5B, 5C, and 5D show example user interfaces for presenting data related to parking information based on data from one or more vehicle sensors in accordance with some embodiments of the disclosed subject matter.

FIG. 6 shows a detailed example of hardware that can be used in a gateway device, a server, and/or a user device in accordance with some embodiments of the disclosed subject matter.

### DETAILED DESCRIPTION

In accordance with various embodiments, wireless occupancy sensors and methods for using the same. In some embodiments, wireless occupancy sensors that can be used to provide privacy-sensitive mechanisms (which can include methods, systems, and media) for detecting the presence of a vehicle and generating and/or presenting real-time parking information.

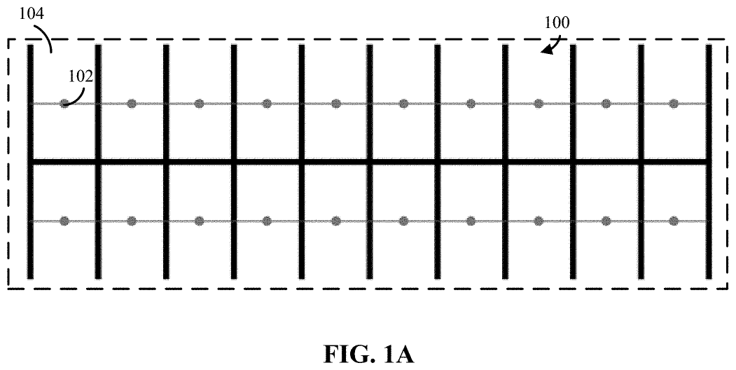

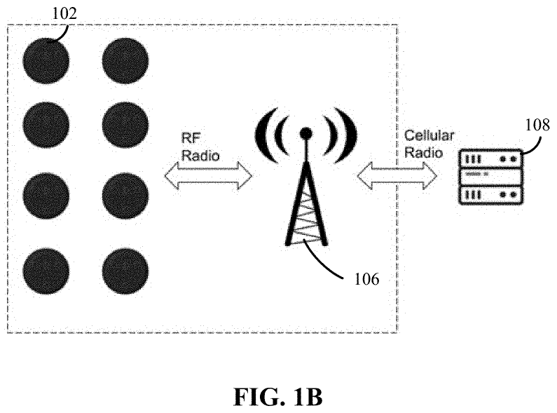

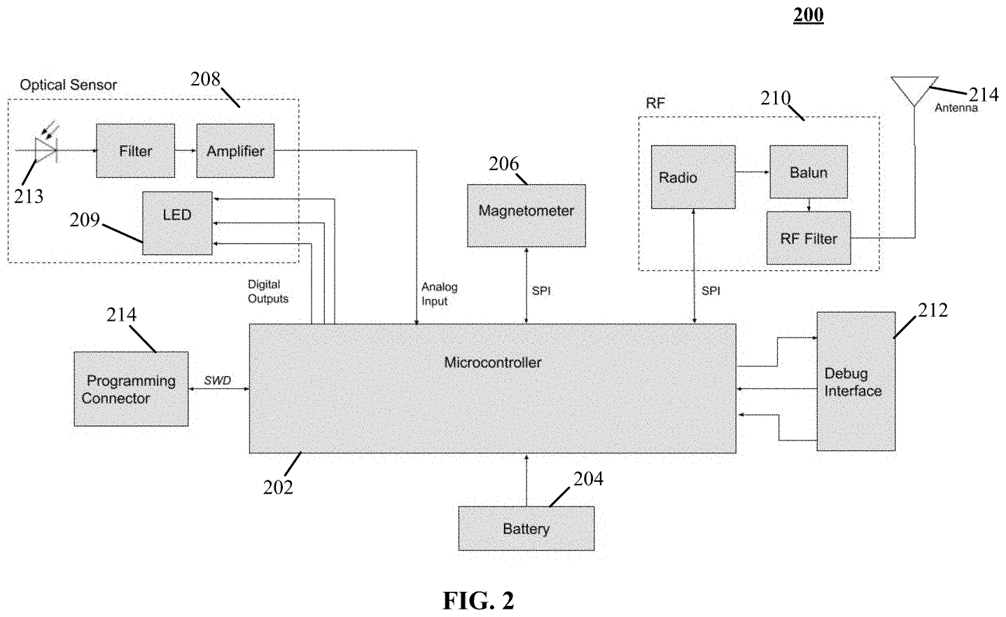

In some embodiments, the mechanisms described herein can include a vehicle sensor that can determine whether a vehicle (e.g., a car, a truck, a motorcycle, etc.) is positioned over the vehicle sensor. In some embodiments, as shown in and described below in connection with FIGS. 1A, 1B, and 2, the vehicle sensor can include a magnetometer, which can detect changes in a magnetic field when a vehicle moves over the magnetometer. In some embodiments, a change in the magnetic field detected by the magnetometer can trigger an infrared sensor that detects infrared light reflected from an infrared light source. In some embodiments, the amount of reflected light can be used to determine that a vehicle is positioned over the vehicle sensor. In some embodiments, a vehicle sensor can be positioned at any suitable location, such as on the ground in a parking spot, and/or in any other suitable location, as shown in and described below in connection with FIG. 1A. In some embodiments, each parking spot in a parking lot or garage can have a vehicle sensor placed in the spot.

In some embodiments, data from the vehicle sensor can be stored in any suitable manner. For example, in some embodiments, a group of vehicle sensors can each transmit (e.g., via a radio frequency link, and/or in any other suitable manner) sensor data to a gateway device. In some such embodiments, the gateway device can be located at any suitable location. For example, in some embodiments, the gateway device can be located in a parking lot and can receive data from all of the vehicle sensors located in the parking lot. In some embodiments, the gateway device can then transmit (e.g., via cellular uplink, and/or in any other suitable manner) the data to a server that collates parking information from multiple parking lots or garages.

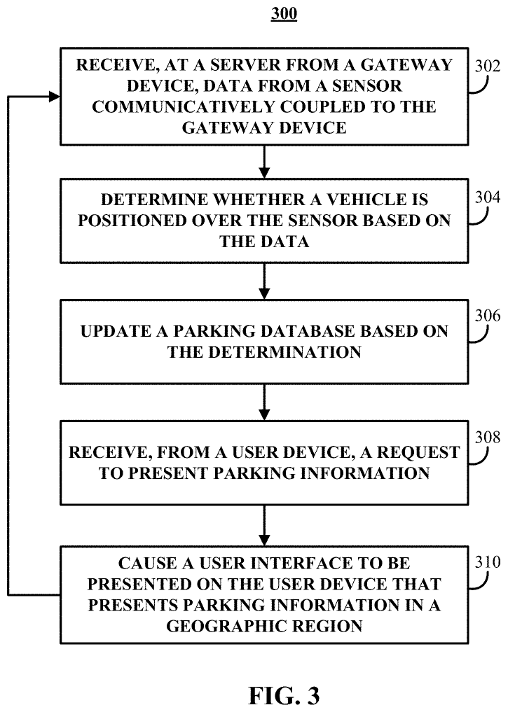

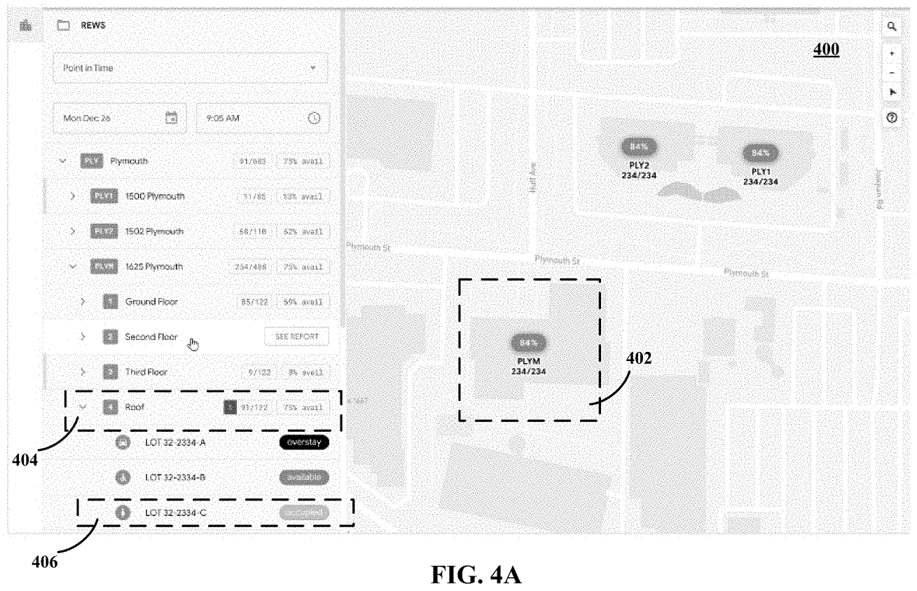

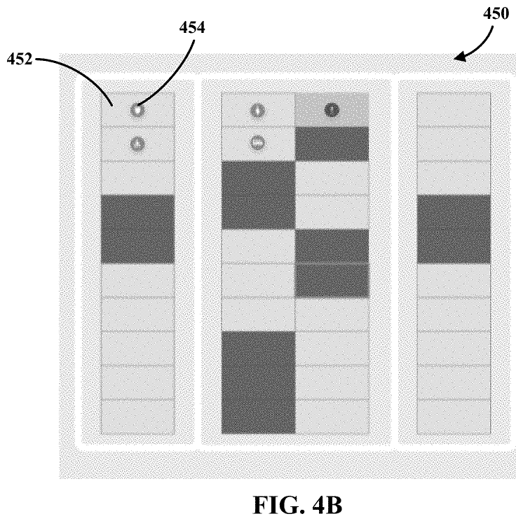

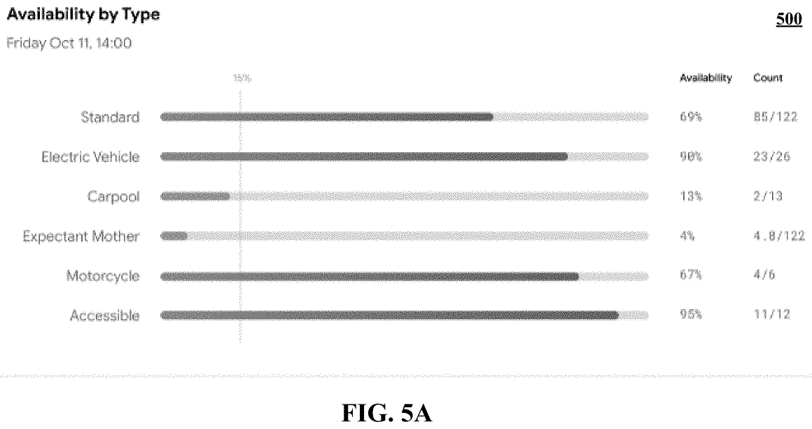

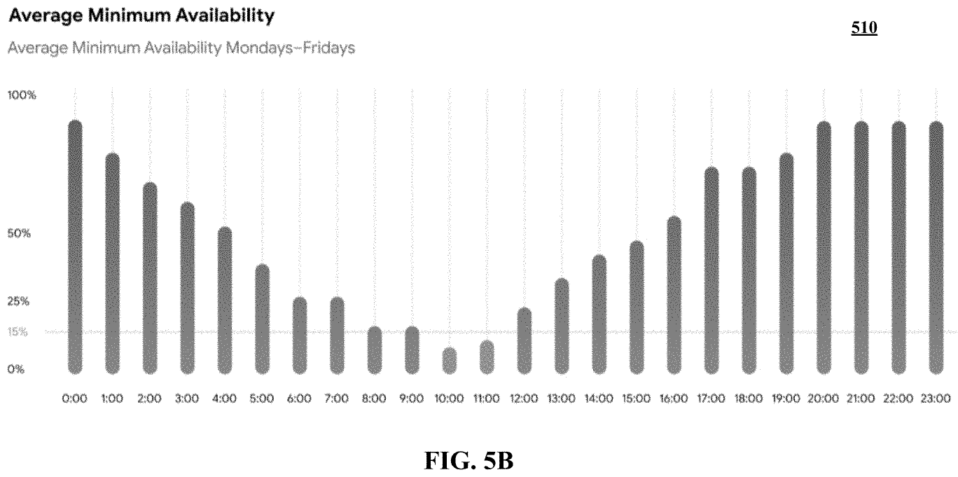

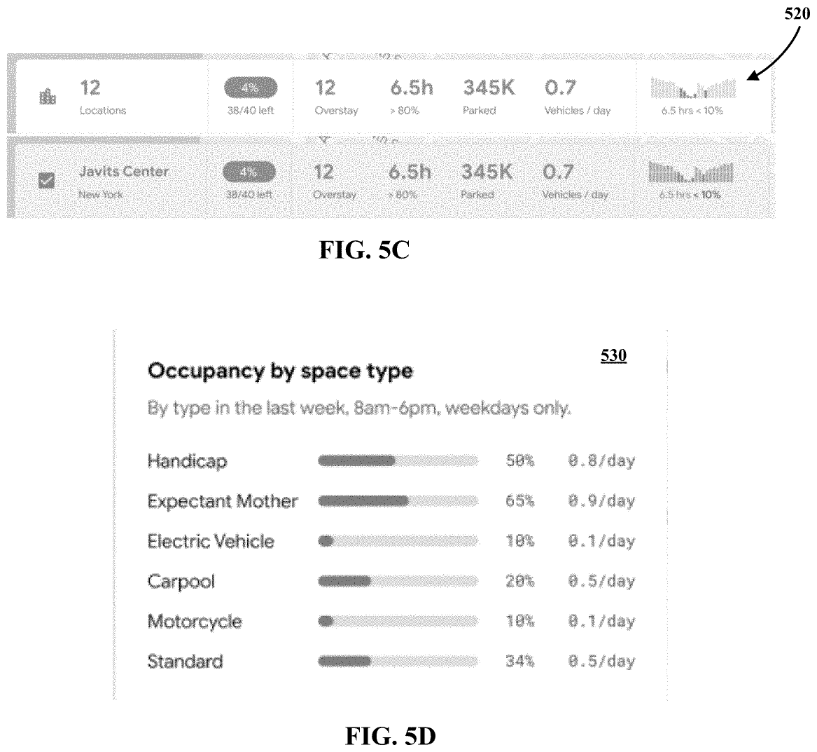

In some embodiments, as shown in and described below in connection with FIG. 3, the server can present any suitable parking information based on the received data from the vehicle sensors. For example, in some embodiments, the server can generate user interfaces that indicate currently available parking spots in a particular parking lot or garage, as shown in and described below in connection with FIGS. 4A and 4B. As another example, in some embodiments, the server can generate user interfaces (e.g., as shown in FIGS. 5A, 5B, 5C, and/or 5D) that can be used to analyze usage of a parking lot or garage by any suitable entity, such as an administrator of a parking lot or gate, an urban planner, and/or any other suitable entity.

It should be noted that the wireless occupancy sensors described herein can be used in any suitable application. For example, although the embodiments described herein generally describe the wireless occupancy sensors as parking sensors to determine whether a vehicle is currently parked in a particular spot, this is merely illustrative. The wireless occupancy sensors can be used to detect the number of vehicles that are currently parked in a parking lot and can be used to dynamically set prices for parking in the parking lot based on current availability (e.g., such that the price is relatively lower in instances in which the current availability is greater than a predetermined availability threshold and such that the price is relatively higher in instances in which the current availability is below a predetermined availability threshold). In another example, the wireless occupancy sensors can be configured at a traffic intersection to control a traffic light. In yet another example, the wireless occupancy sensors can be used to dynamically route vehicles to curbside parking or drop off spots (e.g., upon detecting the parking area as being available, the parking area can be reserved for a vehicle that is making a delivery, picking up or dropping off a passenger, etc. In continuing this example, such a vehicle can receive dynamic directions to a currently available parking spot based on current occupancy as detected by the wireless occupancy sensors.

These and other features of the wireless occupancy sensors are further described in connection with FIGS. 1A-6.

Turning to FIG. 1A, a schematic diagram that illustrates placements of vehicle sensors is shown in accordance with some embodiments of the disclosed subject matter. As illustrated, a parking lot 100 can include a group of parking spaces, such as a parking space 104. Note that, in some embodiments, parking lot 100 can be any suitable type of parking lot or garage, such as an open-air parking lot, a covered parking garage, a parking garage with multiple levels, and/or any other suitable type of lot or garage. Additionally, note that, although parking lot 100 is shown in FIG. 1A as having parking spaces arranged in a grid, in some embodiments, the parking spaces can be arranged in any suitable shape or orientation, such as in a line. Additionally, note that, in some embodiments, parking lot 100 can correspond to any suitable group of curbside parking spaces, such as parking spaces along a particular block of a street.

As shown in FIG. 1A, each parking space can have a corresponding vehicle sensor. For example, as shown in FIG. 1A, parking space 104 has a vehicle sensor 102. In some embodiments, each vehicle sensor can be placed at any suitable location within the parking space. For example, as shown in FIG. 1A, each vehicle sensor can be placed at a center point within the parking space. As another example, in some embodiments, a vehicle sensor can be placed at any other suitable location, such as a front portion of the parking space, a back portion of the parking space, and/or at any other suitable location. Note that, in some embodiments, each vehicle sensor can be assigned an identifier that corresponds to the parking space in which it is placed.

In some embodiments, vehicle sensor 102 can detect a vehicle (e.g., a car, a truck, a motorcycle, and/or any other suitable type of vehicle) over vehicle sensor 102 in any suitable manner. For example, in some embodiments, vehicle sensor 102 can detect a car using an infrared sensor and/or a magnetometer, as discussed below in more detail in connection with FIGS. 2 and 3.

Turning to FIG. 1B, an example of a schematic diagram for transmitting parking information from vehicle sensors is shown in accordance with some embodiments of the disclosed subject matter.

As illustrated in FIG. 1B, each vehicle sensor, such as vehicle sensor 102, can transmit information to a gateway device 106. In some embodiments, vehicle sensor 102 can transmit information to gateway device 106 in any suitable manner, such as via any suitable radio transmission protocol operating at any suitable frequency (e.g., 915 MHz, 920 MHz, 925 MHz, and/or any other suitable frequency). In some embodiments, the transmitted information can include any suitable information, such as an identifier of vehicle sensor 102 (e.g., that uniquely identifies a location of vehicle sensor 102), magnetometer readings and/or infrared sensor readings that can be used to determine whether a car is parked in a parking spot corresponding to vehicle sensor 102, and/or any other suitable information. In some embodiments, the transmitted information can be encrypted in any suitable manner and using any suitable encryption keys.

Note that, in some embodiments, vehicle sensor 102 can transmit information to gateway device 106 at any suitable time point(s). For example, in some embodiments, vehicle sensor 102 can be configured to transmit information to gateway device 106 in response to determining, based on readings from the magnetometer and/or the infrared sensor, that a change in a parking status of the parking spot corresponding to vehicle sensor 102 has occurred (e.g., that a car has parked in the parking spot when at a previous time point no car was parked, that a car is no longer parked in a previously occupied parking spot, and/or any other suitable change in parking status). As another example, in some embodiments, vehicle sensor 102 can be configured to transmit information to gateway device 106 at any suitable predetermined frequency (e.g., once per minute, once per five minutes, once per ten minutes, and/or any other suitable frequency). As a more particular example, in some embodiments, vehicle sensor 102 can be configured to transmit information to gateway device 106 at a first predetermined frequency (e.g., once per five minutes, and/or any other suitable frequency) during a first time of day (e.g., between 7 am and 7 pm, on weekdays between 9 am and 5 pm, on weekends between 7 pm and midnight, and/or any other suitable time of day), and at a second predetermined frequency (e.g., once per hour, and/or any other suitable frequency) during a second time of day (e.g., between midnight and 8 am, on weekdays between 8 pm and 6 am, and/or any other suitable time of day).

In some embodiments, gateway device 106 can be any suitable device for receiving information from any suitable number of vehicle sensors (e.g., ten, twenty, one hundred, one thousand, and/or any other suitable number), and forwarding the received information to a server 108. For example, in some embodiments, gateway device 106 can receive data from a group of vehicle sensors located on the same level as gateway device 106 of a parking garage. As another example, in some embodiments, gateway device 106 can receive data from a group of vehicle sensors within a predetermined proximity to gateway device 106 (e.g., within 500 feet, within 2000 feet, and/or any other suitable predetermined proximity). Note that, in some embodiments, gateway device 106 can have any suitable power supply. For example, in some embodiments, gateway device 106 can be solar-powered, with solar panels located at any suitable position(s) on gateway device 106. As another example, in some embodiments, gateway device 106 can have any suitable type of battery (e.g., a replaceable battery, a rechargeable battery, and/or any other suitable type of battery).

In some embodiments, gateway device 106 can forward the information received from vehicle sensor 102 to server 108 in any suitable manner. For example, in some embodiments, gateway device 106 can forward the information via a cellular uplink. In some embodiments, gateway device 106 can transmit the information to server 108 using any suitable data transmission protocol, such as User Datagram Protocol (UDP), Hypertext Transfer Protocol (HTTP), HTTPS, MQ Telemetry Support (MQTT), and/or any other suitable protocol.

In some embodiments, server 108 can be any suitable server for collecting information from multiple vehicle sensors in different locations and providing any suitable parking information. For example, as shown in and discussed below in connection with FIG. 3, server 108 can present information indicating whether a particular parking space is occupied, a number of currently available parking spaces in a particular parking lot or garage, and/or any other suitable information. As another example, as shown in and discussed below in connection with FIGS. 5A, 5B, 5C, and 5D, server 108 can present an analysis of parking occupancy at particular locations, particular times of day, and/or any other suitable analysis.

Turning to FIG. 2, an example 200 of a schematic for hardware that can be used in a vehicle sensor is shown in accordance with some embodiments of the disclosed subject matter. As illustrated, vehicle sensor 200 can include a microcontroller 202, a battery 204, a magnetometer 206, an optical sensor interface 208, a radio frequency (RF) interface 210, a debug interface 212, and/or a programming connector 214.

In some embodiments, microcontroller 202 can execute any suitable instructions or computer programs associated with the vehicle sensor. For example, in some embodiments, microcontroller 202 can execute any suitable instructions for collecting and/or or storing readings from magnetometer 206, collecting and/or storing readings from optical sensor interface 208, transmitting readings to a gateway device via RF interface 210, updating firmware on microcontroller 202 (e.g., using programming connector 214, and/or in any other suitable manner), and/or perform any other suitable function(s). As another example, in some embodiments, microcontroller 202 can encrypt messages transmitted to a gateway device using any suitable encryption protocol(s). In some embodiments, any suitable encryption keys can be stored in a memory of the vehicle sensor which can be accessed by microcontroller 202. In some embodiments, microcontroller 202 can execute instructions using any suitable computer language, such as C, C++, Java, Python, Go, and/or any other suitable computer language.

In some embodiments, battery 204 can be any suitable type of battery that serves as a power source for the vehicle sensor. For example, in some embodiments, battery 204 can be a non-replaceable battery. As another example, in some embodiments, battery 204 can be a replaceable battery. Note that, in some embodiments, battery 204 can have any suitable characteristics such that the battery can provide any suitable voltage (e.g., between 2.5 V and 3.6 V, and/or any other suitable voltage) over its intended lifetime. Additionally, note that, in some embodiments, battery 204 can have any suitable characteristics such that battery 204 can have any suitable intended battery life (e.g., five years, ten years, fifteen years, and/or any other suitable intended battery life). Also note that, in some embodiments, battery 204 can be a rechargeable battery, where the battery may be charged using solar power or by harvesting other available power sources in-situ. For example, the vehicle sensor can include solar panels located at any suitable position(s) on the vehicle sensor in which power can be converted and/or otherwise transmitted from one or more solar panels to battery 204 via one or more electrical connectors (e.g., wires, cables, and/or any other suitable type of electrical connectors).

In some embodiments, magnetometer 206 can be any suitable sensor that senses a change in a magnetic field. For example, in some embodiments, magnetometer 206 can be a magnetometer that detects a change in a magnetic field in response to an object being placed over and/or in proximity to magnetometer 206, such as a car or other vehicle. Note that, in some embodiments, magnetometer 206 can be any suitable type of magnetometer that measures a magnetic field along any suitable vector (e.g., any suitable (X, Y, Z) vector). In some embodiments, magnetometer 206 can transmit readings to microcontroller 202 via a serial interface, as shown in FIG. 2. For example, such an interface can include a Serial Peripheral Interface (SPI) interface, a Universal Asynchronous Receiver/Transmitter (UART) interface, an Inter-Integrated Circuit (I2C) interface, or any other suitable interface.

In a more particular example, magnetometer 206 can be a low-power magnetometer that is positioned to detect whether a curb space or a parking space is being occupied by a vehicle.

In some embodiments, optical sensor interface 208 can include any suitable components. For example, in some embodiments, optical sensor interface 208 can include an LED 209 and a light sensor 213, where LED 209 emits light and light sensor 213 measures an amount of reflected light. In some embodiments, the amount of reflected light measured by light sensor 213 can indicate whether or not an object (e.g., a car) is positioned over the vehicle sensor. In some embodiments, LED 209 can emit light in any suitable wavelength (e.g., infrared light, visible light, and/or any other suitable wavelength). Note that, in some embodiments, the emitted light can be of any suitable waveform, e.g., pulses of light, a constant emission at a particular wavelength, and/or any other suitable type of emitted light. In some embodiments, optical sensor interface 208 can include any other suitable components, such as a filter, an amplifier, and/or any other suitable components. As shown in FIG. 2, a connection between optical sensor interface 208 and microcontroller 202 can include any suitable materials and/or components. For example, as shown in FIG. 2, LED 209 can be connected to microcontroller 202 via one or more digital output channels. As another example, in some embodiments, an amplifier of optical interface 208 that amplifies a measurement of light sensor 213 can be connected to microcontroller 202 via any suitable analog General Purpose I/O (GPIO) interface.

Note that, in some embodiments, optical sensor interface 208 can be triggered based on a reading from magnetometer 206. For example, in some embodiments, in response to detecting a change in a magnetic field based on a reading from magnetometer 206, microcontroller 202 can trigger or otherwise activate optical sensor interface 208. As a more particular example, in some embodiments, by triggering optical sensor interface 208, microcontroller 202 can cause light to be emitted from LED 209 and an amount of reflected light to be measured by light sensor 213. In a more particular example, magnetometer 206 can be a low-power magnetometer that is positioned to detect whether a curb space or a parking space is being occupied by a vehicle, where, in response to detecting that a curb space or a parking space may be occupied by a vehicle based on a particular change in magnetic field, magnetometer 206 and/or microcontroller 202 can transmit an instruction to turn on, wake up, or otherwise activate optical sensor interface 208 that can verify usage of the curb space or parking space by the vehicle.

This can, for example, allow the wireless occupancy sensor to have a low power draw in which a low-power magnetometer is used to detect changes in magnetic field and activating a higher power consuming optical sensor interface upon the change in the magnetic field being greater than a particular threshold value or meeting predetermined criteria.

In some embodiments, RF interface 210 can be used to transmit information from the vehicle sensor to a gateway device using any suitable radio transmission protocol and using any suitable frequency. For example, in some embodiments, RF interface 210 can include any suitable filter(s), an antenna 214, and/or any other suitable components. In some embodiments, RF interface 210 can communicate with microcontroller 202 via an SPI interface, as shown.

In some embodiments, debug interface 212 can be used to debug any suitable functionality of the vehicle sensor.

In some embodiments, the vehicle sensor can be installed at a parking space or any other suitable location using any suitable approach. For example, a vehicle sensor can be installed at a central point of a parking spot by applying an epoxy adhesive to a rear portion of the vehicle sensor. In another example, a vehicle sensor can be temporarily installed at a particular portion of a parking spot by positioning a butyl pad between a rear portion of the vehicle sensor and a particular point within a parking spot. In yet another example, a vehicle sensor can be installed on the curb portion of a street that permits parking by applying an adhesive to a rear portion of the vehicle sensor and positioning the vehicle sensor on a desired portion of the curb.

Turning to FIG. 3, an illustrative example 300 of a process for generating and presenting parking information using one or more vehicle sensors is shown in accordance with some embodiments of the disclosed subject matter. In some embodiments, blocks of process 300 can be executed by any suitable device, such as a server that receives parking information transmitted from a gateway device, as shown in and described above in connection with FIG. 1B.

Process 300 can begin at 302 by receiving, at a server from a gateway device, data from a vehicle sensor communicatively coupled to the gateway device. As shown in and described above in connection with FIGS. 1A and 1B, the vehicle sensor can be any suitable wireless occupancy sensor that detects a presence of a vehicle above the sensor. For example, as described above in connection with FIGS. 1A and 1B, the vehicle sensor can collect any suitable readings from a magnetometer and/or an infrared sensor that can be used to determine a presence of a vehicle. In some embodiments, the data received by the server can be any suitable data, such as one or more magnetometer readings, one or more readings from an infrared sensor, one or more data points from an amplifier connected to a magnetometer and/or infrared sensor, and/or any other suitable data. For example, in some embodiments, the data can include one or more magnetic field vectors using (X, Y, Z) axes. As another example, in some embodiments, the data can include infrared reflectivity data measured by an infrared sensor, as shown in and described above in connection with FIGS. 1A, 1B, and 2.

Note that, in some embodiments, data received from a particular vehicle sensor can be associated with an identifier of a particular parking spot the vehicle sensor is located at. In some embodiments, the identifier can additionally indicate a particular parking lot or parking garage the vehicle sensor is located at. For example, in some embodiments, the identifier can include a parking lot identifier (e.g., “SW Corner of Street 1/Avenue 1,” and/or any other lot or garage identifier) and a parking spot identifier (e.g., “#314,” “#512,” and/or any other suitable parking spot identifier). In instances in which the parking spot is a curbside spot along a street, the identifier can indicate the block the parking spot is located on by identifying one or more streets that define the block as well as a side of the street (e.g., the north side, the south side, the east side, the west side, and/or any other suitable side) the parking spot is located on.

Note that, in some embodiments, process 300 can perform any suitable verification in response to receiving a message from a gateway device. For example, in some embodiments, process 300 can verify or validate that the message was not corrupted in transit in any suitable manner. Additionally, note that, in some embodiments, process 300 can log the message in any suitable manner. For example, in some embodiments, process 300 can store the received message in any suitable database. As another example, in some embodiments, process 300 can store received sensor readings in any suitable cache. Note that, in some embodiments, stored messages and/or data can be accessed at any suitable time for debugging.

Additionally, note that, in instances in which the data received from the gateway device is encrypted in any manner (e.g., encrypted by the vehicle sensor as described above in connection with FIG. 2, encrypted by the gateway device, and/or encrypted by any other suitable device), process 300 can decrypt the data in any suitable manner. For example, in some embodiments, process 300 can use any suitable public key or private key to decrypt a received message.

In some embodiments, the data can be received by the server in any suitable manner. For example, in some embodiments, the data can be received by an event receiver executing on the server that receives a message that includes the data. Continuing with this example, in some embodiments, the event receiver can, in response to receiving a message from a gateway device, cause additional blocks of process 300 to be executed, as described below.

At 304, process 300 can determine whether a vehicle (e.g., a car, a truck, a motorcycle, etc.) is positioned over the vehicle sensor based on the data. In some embodiments, process 300 can determine whether a vehicle is parked over the vehicle sensor using any suitable technique(s). For example, in some embodiments, process 300 can determine whether a vehicle is positioned over the vehicle sensor using infrared reflectivity data that indicates an amount of reflected light. As a more particular example, in some embodiments, process 300 can determine that a vehicle is positioned over the vehicle sensor in response to determining that more light is reflected than a baseline amount of reflected light at a time when no vehicle is positioned over the vehicle sensor. As a specific example, in some embodiments, process 300 can determine that a vehicle is positioned over the vehicle sensor in response to determining that the amount of reflected light exceeds a predetermined threshold.

Note that, in some embodiments, the gateway device can determine whether a vehicle is positioned over the vehicle sensor. In some such embodiments, rather than receiving data from the vehicle sensor that is forwarded by the gateway device to the server, the server can receive information indicating the determination by the gateway device of whether a vehicle is positioned over the vehicle sensor.

At 306, process 300 can update a parking database based on the determination. For example, in some embodiments, process 300 can use an identifier included in the data received at 302 as a database key to identify the parking spot in the parking database. Continuing with this example, process 300 can then update the database using the determination from 304. As a more particular example, in response to determining that a vehicle is present in the parking spot, process 300 can update the database to indicate that the parking spot is currently occupied. As another more particular example, in an instance in which the determination at 304 is that there is no vehicle present, and in which the database previously indicated that the parking spot had been occupied, process 300 can update the database to indicate that the parking spot is currently unoccupied. Note that, in some embodiments, process 300 can update the database in connection with a timestamp that indicates a time at which the data was collected by the vehicle sensor. In some embodiments, the timestamp can be used for any suitable function(s), such as to determine whether a vehicle has been parked in the parking spot for longer than is allowed, to determine an average duration of time vehicles park in particular parking lots, and/or for any other suitable information.

Note that, in some embodiments, the parking database can store any suitable information about parking lots and/or individual parking spots. For example, in some embodiments, the parking database can store information about an individual parking spot, such as a time limit available for that parking spot, whether the parking spot is reserved for a particular group of people or a particular activity (e.g., whether the parking spot is a handicapped spot, a parking spot reserved for a quick pick-up in a store, a parking spot reserved for deliveries, and/or any other suitable type of reserved spot), whether the parking spot has a station for charging electric vehicles, and/or any other suitable information. As another example, in some embodiments, the parking database can store information about the parking lot or garage the parking spot is located in, such as a total number of parking spots in the lot or garage, a total number of a particular type of parking spot (e.g., handicapped-reserved spots, electrical vehicle charging spots, and/or any other suitable type of parking spot).

Additionally, note that, in instances in which a particular parking spot is associated with any particular criteria for parking, for example, that a particular fee must be paid, that parking is restricted to a predetermined number of hours (e.g., two hours, five hours, and/or any other suitable number of hours), process 300 can determine, via the parking database, whether a vehicle currently occupying a parking spot is in compliance with the criteria. For example, in an instance in which a parking spot may only be occupied for two hours, process 300 can determine whether a vehicle currently occupying the parking spot has been parked for more than two hours. In some embodiments, process 300 can transmit a notification to any suitable entity in response to determining that a vehicle does not meet criteria associated with the parking spot, such as to a parking enforcement agency, an administrator of the parking lot or garage the parking spot is located in, and/or to any other suitable entity.

At 308, process 300 can receive, from a user device, a request to present parking information. In some embodiments, the request can be from a user device associated with any suitable user. For example, in some embodiments, the request can be from a user who wants to find a parking space. As a more particular example, in some embodiments, the request can be from a user who wants to view user interfaces that show a number of available parking spaces in a particular parking lot or garage, a number of available parking spaces of a particular type (e.g., handicapped-reserved spots, reserved for deliveries, equipped with electrical vehicle charging ports, and/or any other suitable type of parking spot) available in a particular parking lot or garage, and/or any other suitable parking information. As another example, in some embodiments, the request can be from a user who wants to view or analyze parking metrics in a geographical region, such as an administrator of a parking agency, an administrator at an urban planning agency, and/or any other suitable type of user. In some embodiments, the request from the user device can be via a particular application executing on the user device (e.g., an application for finding a parking space, and/or any other suitable type of application). In some embodiments, the request from the user device can be via a website presented in a browser of the user device (e.g., a website for presenting parking metrics or analysis, a website for finding a parking space, and/or any other suitable type of website).

At 310, process 300 can cause a user interface to be presented on the user device that presents the requested parking information. Note that, in some embodiments, information presented in the user interface can be retrieved from the parking database described above in connection with 306.

Turning to FIG. 4A, an illustrative example 400 of a user interface for presenting parking space information is shown in accordance with some embodiments of the disclosed subject matter.

In some embodiments, user interface 400 can include a map 401 that indicates different parking lots or garages in a geographical region (e.g., in a city, in a town, in a neighborhood, and/or any other suitable geographical region), such as a garage 402. Note that, in some embodiments, map 401 can be zoomed in or out and/or manipulated in any suitable manner, such as via a touchscreen of the device the map is presented on, via a mouse, and/or in any other suitable manner.

In some embodiments, user interface 400 can include a hierarchical list 403 that presents information relating to different parking lots or garages. For example, as shown in user interface 400, a top level of hierarchical list 403 can list a name of a geographical region shown in map 401 (e.g., “Plymouth”). Continuing with this example, as shown in user interface 400, the top level of hierarchical list 403 can be expanded to show different parking lots or garages located in the geographical region (e.g., “1500 Plymouth,” “1502 Plymouth,” “1625 Plymouth”). Continuing further with this example, in some embodiments, any of the parking lots or garages can be expanded within hierarchical list 403 to show different regions or portions of the selected parking lot or garage (e.g., Roof 404 as shown in FIG. 4A, the ground floor, the first floor, etc.). Continuing still further with this example, in some embodiments, a particular region or portion of the parking lot or garage can be expanded to show information about individual parking spaces within the region of the parking lot, such as parking spot 406. In some embodiments, the information can indicate any suitable information, such as whether the parking spot is available or occupied, whether a vehicle currently parked in the spot has overstayed a time limit associated with the spot, and/or any other suitable information.

In some embodiments, the parking information associated with individual parking spots can be presented in a map format, as shown in FIG. 4B. Turning to FIG. 4B, an example 450 of a user interface for presenting parking information in a map format is shown in accordance with some embodiments of the disclosed subject matter.

As illustrated, user interface 450 can present a map of different parking spaces within a parking lot or garage, such as parking spot 452. Note that, in some embodiments, each parking spot can be colored or shaded in a visual manner that indicates a current status of the parking spot (e.g., available, occupied, the current occupant has overstayed a time limit, and/or any other suitable status). Additionally, as shown in user interface 450, parking spot 452 can include an icon 454 that indicates a parking spot type associated with the parking spot. For example, in some embodiments, icon 454 can indicate that the parking spot has equipment for charging an electric vehicle, that the parking spot is a handicapped-reserved spot, that the parking spot is reserved for quick deliveries, and/or any other suitable parking spot type.

Turning to FIGS. 5A, 5B, 5C, and 5D, examples of user interfaces for presenting an analysis of parking information is shown in accordance with some embodiments of the disclosed subject matter. In some embodiments, the user interfaces shown in FIGS. 5A, 5B, 5C, and/or 5D can be presented on a user device of a user or an entity who has access to the parking database for planning (e.g., planning availability of parking resources, urban planning, etc.) and/or parking enforcement.

FIG. 5A shows an illustrative example 500 of a user interface for showing availability of different types (e.g., standard parking spots, electric vehicle parking spots, carpool parking spots, expectant mother parking spots, motorcycle parking spots, handicapped parking spots, and/or any other suitable type of parking spot) of parking spaces within a particular parking lot or garage in accordance with some embodiments of the disclosed subject matter. As illustrated, user interface 500 can show a percentage of currently available spots of each type. Additionally, as shown, user interface 500 can indicate absolute numbers of each type of parking spot and an absolute number of each type of parking spot that is currently available. In some embodiments, user interface 500 can indicate a threshold line 502 (e.g., 15%, 20%, and/or any other suitable threshold) that indicates types of parking spots for which a current availability is below the threshold.

Turning to FIG. 5B, an illustrative example 510 of a user interface for presenting parking spot availability within a particular parking lot or garage at different times of day is shown in accordance with some embodiments of the disclosed subject matter. As illustrated, in some embodiments, user interface 510 can include a threshold line 512 that indicates a threshold level of availability (e.g., 15%, 20%, and/or any other suitable threshold). As shown in FIG. 5B, threshold line 512 can allow a viewer of user interface 510 to easily identify times of day when parking availability is below the threshold corresponding to threshold line 512.

Turning to FIG. 5C, an illustrative example 520 of a user interface for presenting an analysis of parking data is shown in accordance with some embodiments of the disclosed subject matter. As illustrated, user interface 520 can present any suitable information, such as a current availability in a particular parking lot or garage (e.g., an absolute number of available parking spots, a percentage of parking spots that are currently available, and/or any other suitable availability metric), a number of vehicles that are currently occupying parking spots beyond a time limit, an average time duration of the day during which more than a predetermined percentage of the parking lot or garage is occupied, a graph of parking availability at different times of day, and/or any other suitable information. Note that, in some embodiments, the information can be presented for a particular parking lot and/or garage. Additionally or alternatively, in some embodiments, the information can be collated and presented for multiple parking lots and/or garages in a particular geographical region.

Turning to FIG. 5D, an illustrative example 530 of a user interface for presenting an analysis of parking information by parking spot type is shown in accordance with some embodiments of the disclosed subject matter. As illustrated in user interface 530, an average percentage occupancy of different types of parking spots can be shown over any suitable time period (e.g., from 8 am-6 pm on weekdays, at all times on weekdays, on weekends, and/or any other suitable time period).

Note that the information provided in the user interfaces shown in FIGS. 5A, 5B, 5C, and 5D can be used for any suitable purpose. For example, a user viewing the information shown in FIGS. 5A, 5B, 5C, and/or 5D that indicates relatively low availability of particular types of parking spots at particular times can determine that additional parking of that type should be added at the particular times. As a more particular example, in an instance in which the information indicates that less than a predetermined threshold of parking spots of a particular type (e.g., for charging electric vehicles, and/or any other suitable type of parking spot) are available at a particular time of day on average, a user (e.g. associated with administration of a particular parking lot or garage) can determine that additional parking spots are to be added of that type and/or that parking spot types should be reallocated. Moreover, referring back to FIG. 3, in some embodiments, process 300 can automatically transmit a notification or alert to a particular user device in response to determining that parking spots of a particular type have less than a predetermined threshold of availability at particular times of day and/or on particular days of the week.

Note that, in some embodiments, process 300 can retrieve the data used to generate the information presented in the user interfaces of FIGS. 4A, 4B, 5A, 5B, 5C, and/or 5D in any suitable manner. For example, in some embodiments, process 300 can transmit a query to the parking database requesting parking data with any suitable parameters. As a more particular example, the query can specify a particular parking lot or garage. As another more particular example, the query can specify timing information corresponding to data that is to be retrieved (e.g., data corresponding to a particular time of day or particular days of the week, data from the past week, and/or any other suitable timing information). As another more particular example, the query can indicate that data corresponding to particular types of parking spots is to be retrieved (e.g., handicapped-reserved spots, electrical vehicle charging spots, spots reserved for quick deliveries or drop-offs, and/or any other suitable types of parking spots). Note that, in some such embodiments, a query to the parking database can include any suitable combination of query criteria, such as a combination of timing information and parking spot type information.

In some embodiments, process 300 can then loop back to 302 and can receive additional vehicle sensor data.

In some embodiments, the mechanisms described herein can perform any other suitable action(s) or function(s) using data from a vehicle sensor as shown in and described above in connection with FIGS. 1A, 1B, and 2. For example, in some embodiments, data from vehicle sensors can be used to dynamically set prices for parking based on current availability. As a more particular example, in some embodiments, the parking database described above in connection with FIG. 3 can be queried to determine a current parking availability in a particular parking lot or garage. Continuing further with this particular example, in some embodiments, a price can be determined for a parking spot based on the current availability, such that the price is relatively lower in instances in which the current availability is relatively higher (e.g., above a predetermined availability threshold) and relatively higher in instances in which the current availability is relatively lower (e.g., below a predetermined availability threshold). Note that, in some embodiments, prices can be determined for different types of parking spots. For example, in some embodiments, a first price can be determined for a first type of parking spot (e.g., an electric vehicle charging spot) based on current availability of the first type of parking spot, and a second price can be determined for a second type of parking spot (e.g., general parking) based on current availability of the second type of parking spot.

As another example, in some embodiments, a vehicle sensor as shown in and described above in connection with FIGS. 1A, 1B, and 2 can be used at traffic intersections for any suitable purpose. For example, in some embodiments, a vehicle sensor can be used to toggle a traffic light. As a more particular example, in some embodiments, a traffic light on a busy road can be turned to red in response to detecting a vehicle over a vehicle sensor placed on a less busy road at an intersection point with the busy road.

As yet another example, in some embodiments, a vehicle sensor as shown in and described above in connection with FIGS. 1A, 1B, and 2 can be used to dynamically route vehicles to curbside parking or drop off spots. For example, in an instance in which a vehicle is to stop along a street to make a delivery (e.g., a package delivery, a food delivery, and/or any other suitable type of delivery) and/or to pick up or drop off passengers in a ride-sharing vehicle, the vehicle can receive dynamic directions to a currently available parking spot based on current occupancy as detected by one or more vehicle sensors in the vicinity of the drop off location. As a more particular example, in an instance in which a vehicle is to stop on a particular block in which a drop-off address is located to make a delivery, a user device associated with the vehicle (e.g., associated with a driver of the vehicle, a vehicle information and entertainment device, and/or any other suitable type of user device) can receive an indication of an available curbside spot closest to the drop-off location such that the vehicle can drive to the available curbside spot. In some such embodiments, the user device can be configured to automatically query the parking database (e.g., via an application executing on the user device, and/or in any other suitable manner) in response to detecting that the user device has arrived within a predetermined proximity of the drop-off location (e.g., within 0.25 miles, within 0.3 miles, and/or any other suitable proximity) Continuing further with this example, in some embodiments, the parking database can then return an identifier (e.g., a GPS location, and/or any other suitable identifying information) corresponding to a vehicle sensor corresponding to a currently unoccupied curbside drop-off point nearest to the drop-off location. Continuing still further with this example, in some embodiments, navigation software executing on the user device can be configured to direct the vehicle or a driver of the vehicle to the specified available location. Note that, in some such embodiments, the navigation techniques as described above can be implemented by a human or by an autonomous vehicle.

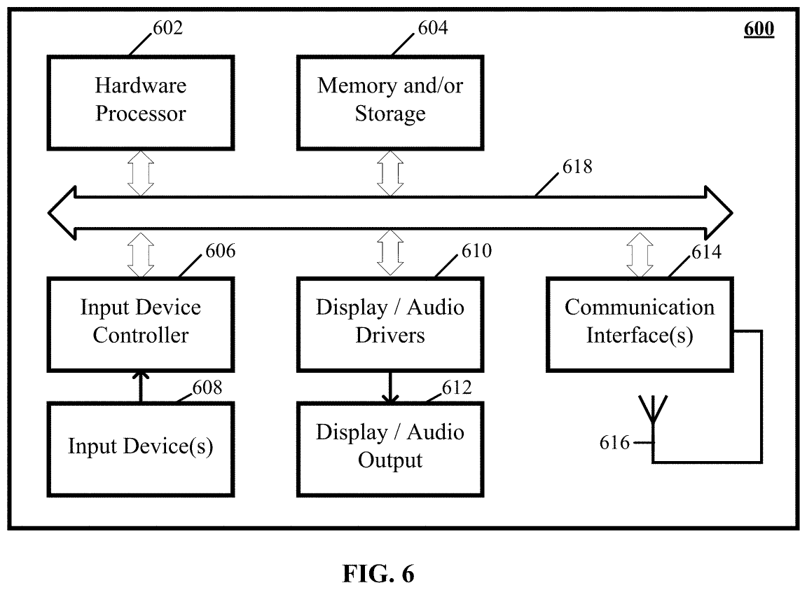

A server, a gateway device, and/or a user device can be implemented using any suitable hardware in some embodiments. For example, in some embodiments, a device can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 600 of FIG. 6, such hardware can include hardware processor 602, memory and/or storage 604, an input device controller 606, an input device 608, display/audio drivers 610, display and audio output circuitry 612, communication interface(s) 614, an antenna 616, and a bus 618.

Hardware processor 602 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 602 can be controlled by a server program stored in memory and/or storage of a server. In some embodiments, hardware processor 602 can be controlled by a computer program stored in memory and/or storage 604 of a gateway device and/or a user device.

Memory and/or storage 604 can be any suitable memory and/or storage for storing programs, data, and/or any other suitable information in some embodiments. For example, memory and/or storage 604 can include random access memory, read-only memory, flash memory, hard disk storage, optical media, and/or any other suitable memory.

Input device controller 606 can be any suitable circuitry for controlling and receiving input from one or more input devices 608 in some embodiments. For example, input device controller 606 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 610 can be any suitable circuitry for controlling and driving output to one or more display/audio output devices 612 in some embodiments. For example, display/audio drivers 610 can be circuitry for driving a touchscreen, a flat-panel display, a cathode ray tube display, a projector, a speaker or speakers, and/or any other suitable display and/or presentation devices.

Communication interface(s) 614 can be any suitable circuitry for interfacing with one or more communication networks. For example, interface(s) 614 can include network interface card circuitry, wireless communication circuitry, and/or any other suitable type of communication network circuitry.

Antenna 616 can be any suitable one or more antennas for wirelessly communicating with a communication network in some embodiments. In some embodiments, antenna 616 can be omitted.

Bus 618 can be any suitable mechanism for communicating between two or more components 602, 604, 606, 610, and 614 in some embodiments.

Any other suitable components can be included in hardware 600 in accordance with some embodiments.

In some embodiments, at least some of the above described blocks of the process of FIG. 3 can be executed or performed in any order or sequence not limited to the order and sequence shown in and described in connection with the figures. Also, some of the above blocks of FIG. 3 can be executed or performed substantially simultaneously where appropriate or in parallel to reduce latency and processing times. Additionally or alternatively, some of the above described blocks of the process of FIG. 3 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, wireless occupancy sensors and methods for using the same are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. An occupancy sensor comprising:
a magnetometer that detects changes in a magnetic field when a vehicle moves over the magnetometer;
an optical sensor that detects one or more objects in a field of view of the optical sensor;
a transmitter for transmitting sensor data to a gateway device, and
a processor that controls the magnetometer, the optical sensor, and the transmitter, wherein the processor is configured to:
detect, using the magnetometer, that a change in the magnetic field is greater than a particular threshold value;
in response to the magnetometer detecting that the change in the magnetic field is greater than the particular threshold value, activating the optical sensor;
receive, using the optical sensor, the sensor data associated with the one or more objects in the field of view of the optical sensor; and
transmit, using the transmitter, the sensor data to the gateway device.

2. The occupancy sensor of claim 1, wherein the magnetometer is a low-power magnetometer.

3. The occupancy sensor of claim 1, wherein the processor is configured to receive the change in the magnetic field from the magnetometer via a serial interface between the magnetometer and the processor.

4. The occupancy sensor claim 1, wherein the optical sensor is an infrared sensor.

5. The occupancy sensor of claim 4, wherein the processor is further configured to determine that the vehicle is positioned over the occupancy sensor based on the amount of reflected light detected by the optical sensor being greater than a baseline amount of reflected light at a time when no vehicle is positioned over the occupancy sensor.

6. The occupancy sensor claim 1, wherein the optical sensor is configured to emit light from a light source and measure an amount of reflected light from the one or more objects in the field of view of the optical sensor and wherein the sensor data includes the amount of reflected light from the one or more objects in the field of view of the optical sensor.

7. The occupancy sensor of claim 6, wherein the light source is a light emitting diode.

8. The occupancy sensor of claim 6, wherein the processor is further configured to determine that the vehicle is positioned over the occupancy sensor based on the amount of reflected light detected by the optical sensor.

9. The occupancy sensor of claim 1, wherein the processor is further configured to transmit data from the magnetometer to the gateway device, wherein the data includes the detected change in the magnetic field when the vehicle moves over the magnetometer.

10. The occupancy sensor of claim 1, wherein the processor is further configured to transmit an identifier associated with a location at which the occupancy sensor is located along with the sensor data associated with the one or more objects in the field of view of the optical sensor.

11. The occupancy sensor of claim 1, wherein the identifier is a parking lot identifier.

12. The occupancy sensor of claim 1, wherein the identifier is a parking spot identifier.

13. The occupancy sensor of claim 1, wherein the processor is further configured to encrypt messages transmitted to the gateway device, wherein the encrypted messages include at least one of the sensor data received from the optical sensor and the detected change in the magnetic field when the vehicle moves over the magnetometer.

14. The occupancy sensor of claim 10, wherein the processor is further configured to store one or more encryption keys in a memory of the occupancy sensor for encrypting messages that transmitted to the gateway device.

15. The occupancy sensor of claim 1, wherein the transmitter is a wireless transmitter and further comprising an antenna coupled to an output of the transmitter.

16. The occupancy sensor of claim 1, wherein the transmitter is a radio frequency transmitter.

17. The occupancy sensor of claim 1, further comprising a battery that is connected to the processor.

18. A parking system comprising:
an occupancy sensor that includes:
a magnetometer that detects changes in a magnetic field when a vehicle moves over the magnetometer;
an optical sensor that detects one or more objects in a field of view of the optical sensor;
a transmitter for transmitting sensor data to a gateway device, and
a processor that controls the magnetometer, the optical sensor, and the transmitter, wherein the processor is configured to:
detect, using the magnetometer, that a change in the magnetic field is greater than a particular threshold value;
in response to the magnetometer detecting that the change in the magnetic field is greater than the particular threshold value, activating the optical sensor;
receive, using the optical sensor, the sensor data associated with the one or more objects in the field of view of the optical sensor; and
transmit, using the transmitter, the sensor data to the gateway device; and
a parking location in which the occupancy sensor is installed at a region of the parking location.

19. The parking system of claim 18, wherein an epoxy adhesive is applied between a rear portion of the occupancy sensor and the region of the parking location.

20. The parking system of claim 18, wherein a butyl pad is positioned between a rear portion of the occupancy sensor and the region of the parking location.
